(19) United States
(12) Patent Application Publication
(10) Pub. No.: US 2015/0184843 A1
(43) Pub. Date: Jul. 2, 2015

(54) BACKLIGHT ASSEMBLY AND DISPLAY APPARATUS HAVING THE SAME

(71) Applicant: SAMSUNG DISPLAY CO., LTD., YONGIN-CITY (KR)

(72) Inventors: Seokhyun Nam, Seoul (KR); Byoung Dae Ye, Gyeonggi-do (KR); Jaesang Lee, Chungcheongnam-do (KR)

(21) Appl. No.: 14/451,788

(22) Filed: Aug. 5, 2014

(30) Foreign Application Priority Data
Dec. 27, 2013 (KR) 10-2013-0165561

(51) Int. Cl. F21V 23/06; F21V 23/00; G02F 1/1335

(52) U.S. Cl. CPC F21V 23/06; G02F 1/1336; F21V 23/005; F21Y 2101/02

(57) ABSTRACT

A display apparatus includes a display panel and a backlight assembly. The display panel displays an image. The backlight assembly emits light onto the display panel. The backlight assembly includes a light source printed circuit board. The light source printed circuit board includes a first contact terminal and a second contact terminal. A plurality of light sources is disposed on the light source printed circuit board and receives power through the first and second contact terminals to generate the light. The driving printed circuit board includes a first power source terminal and a second power source terminal. The driving printed circuit board provides power to the first and second contact terminals through the first and second power source terminals. A socket is disposed on the driving printed circuit board. The socket grips the light source printed circuit board and electrically connects the light source printed circuit board to the driving printed circuit board.

### CROSS-REFERENCE TO RELATED APPLICATION

This U.S. non-provisional patent application claims priority under 35 U.S.C. §119 to Korean Patent Application No. 10-2013-0165561, filed on Dec. 27, 2013, in the Korean Intellectual Property Office, the disclosure of which is incorporated by reference herein in its entirety.

### TECHNICAL FIELD

The present disclosure relates to a display apparatus, and more particularly to a display apparatus having a socket.

### DISCUSSION OF RELATED ART

Flat panel display apparatuses include a liquid crystal display apparatus, a field emission display apparatus, a plasma display panel apparatus, and an organic electroluminescent display apparatus. The liquid crystal display apparatus may include two substrates and a liquid crystal layer disposed therebetween. Electrodes facing each other may be disposed on the two substrates, respectively. Voltages may be applied to the electrodes to rearrange liquid crystal molecules of the liquid crystal layer, so that the amount of light passing through the liquid crystal layer is controlled to display an image.

Liquid crystal display apparatuses may use a backlight assembly to provide light through the liquid crystal layer. The backlight assembly may include a light source printed circuit board on which light sources are disposed, a driving printed circuit board for driving the light source printed circuit board, various optical sheets, and a receiving container for receiving the boards and the sheets.

### SUMMARY

Exemplary embodiments of the present inventive concept provide a display apparatus including a display panel and a backlight assembly. The display panel displays an image. The backlight assembly emits light onto the display panel. The light source printed circuit board includes a first contact terminal and a second contact terminal. A plurality of light sources is disposed on the light source printed circuit board. The plurality of light sources receives power through the first and second contact terminals to generate light. A driving printed circuit board includes a first power source terminal and a second power source terminal. The driving printed circuit board provides power to the first and second contact terminals through the first and second power source terminals. A socket is disposed on the driving printed circuit board. The socket grips the light source printed circuit board and electrically connects the light source printed circuit board to the driving printed circuit board.

Exemplary embodiments of the present inventive concept provide a backlight assembly including a light source printed circuit board, a driving printed circuit board, and a socket. The light source printed circuit board includes a first contact terminal, a second contact terminal and an edge portion. The driving printed circuit board includes a first power source terminal and a second power source terminal. The driving printed circuit board provides power to the first and second contact terminals through the first and second power source terminals. The socket is disposed on the driving printed circuit board. The socket includes a first socket terminal and a second socket terminal. The first and second socket terminals face the edge portion of the light source printed circuit board. The first socket terminal electrically connects the first power source terminal to the first contact terminal, and wherein the second socket terminal electrically connects the second power source terminal to the second contact terminal.

### BRIEF DESCRIPTION OF THE DRAWINGS

The above and other features of the present inventive concept will become more apparent by describing in detail exemplary embodiments thereof, with reference to the accompanying drawings in which:

FIG. 1 is an exploded perspective view showing a display apparatus according to exemplary embodiments of the present inventive concept;

FIG. 2A is a separated perspective view showing a connection part of a light source printed circuit board and a driving printed circuit board in a display apparatus according to exemplary embodiments of the present inventive concept;

FIG. 2B is a combined perspective view showing a connecting part of a light source printed circuit board and a driving printed circuit board in a display apparatus according to exemplary embodiments of the present inventive concept;

FIG. 3 is a cross-sectional view taken along a line I-I′ of FIG. 2B;

FIG. 4 is a cross-sectional view showing a connection part of a light source printed circuit board and a driving printed circuit board in a display apparatus according to an exemplary embodiment of the present inventive concept;

FIG. 5A is a separated perspective view showing a connection part of a light source printed circuit board and a driving printed circuit board in a display apparatus according to an exemplary embodiment of the present inventive concept;

FIG. 5B is a combined perspective view showing a connecting part of a light source printed circuit board and a driving printed circuit board in a display apparatus according to an exemplary embodiment of the present inventive concept; and

FIG. 6 is a cross-sectional view taken along a line of FIG. 5B.

### DETAILED DESCRIPTION OF THE EMBODIMENTS

Exemplary embodiments of the present inventive concept will now be described more fully hereinafter with reference to the accompanying drawings, in which exemplary embodiments are shown. The aspects and features of the present inventive concept will be apparent from the following exemplary embodiments that will be described in more detail with reference to the accompanying drawings. It should be noted, however, that the inventive concept is not limited to the following exemplary embodiments, and may be implemented in various forms. In the drawings, exemplary embodiments of the present inventive concept are not limited to the specific examples provided herein.

The terminology used herein is for the purpose of describing exemplary embodiments and is not intended to limit the present inventive concept. It will be understood that when an element is referred to as being “connected” or “coupled” to another element, it may be directly connected or coupled to the other element or intervening elements may be present.

It will be understood that when an element such as a layer, region or substrate is referred to as being “on” another element, it can be directly on the other element or intervening elements may be present. Shapes of the exemplary views may be modified according to manufacturing techniques and/or allowable errors. The exemplary embodiments of the present inventive concept are not limited to the specific shapes illustrated in the exemplary views, but may include other shapes that may be created according to manufacturing processes. Areas exemplified in the drawings may have general properties, and may be used to illustrate specific shapes of elements. Thus, this should not be construed as limiting to the scope of the present inventive concept.

It will be also understood that although the terms first, second, third etc. may be used herein to describe various elements, these elements should not be limited by these terms. These terms may be used to distinguish one element from another element. Thus, a first element in exemplary embodiments of the present inventive concept may be termed a second element in other embodiments without departing from the teachings of the present inventive concept. Exemplary embodiments of aspects of the present inventive concept explained and illustrated herein may include their complementary counterparts. The same reference numerals or the same reference designators may denote the same elements throughout the specification.

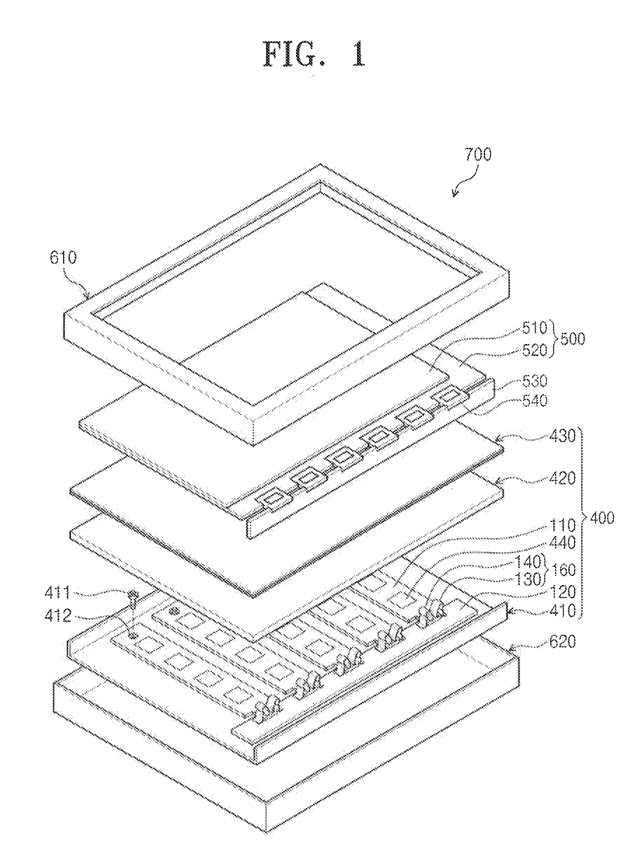

FIG. 1 is an exploded perspective view showing a display apparatus according to exemplary embodiments of the present inventive concept.

Referring to FIG. 1, a display apparatus 700 may include a backlight assembly 400 configured to generate light, a display panel 500 configured to receive the light from the backlight assembly 400 and to display an image, a cover member 610, and a receiving member 620 configured to receive the backlight assembly 400, the display panel 500 and the cover member 610.

The backlight assembly 400 may include a reflective plate 410, a light source printed circuit board 110 disposed on the reflective plate 410, a plurality of light sources 440 disposed on the light source printed circuit board 110, a driving printed circuit board 120 electrically connected to the light source printed circuit board 110, a first optical member 420, and a second optical member 430. The driving printed circuit board 120 may provide power to the light source printed circuit board 110. In exemplary embodiments of the present inventive concept, a plurality of light source printed circuit boards 110 may be disposed on the reflective plate 410, as shown in FIG. 1. The plurality of light source printed circuit boards 110 may be arranged in parallel to each other and may be electrically connected to the driving printed circuit board 120.

The light sources 440 may be disposed on the light source printed circuit board 110 at predetermined intervals. In exemplary embodiments of the present inventive concept, each of the light sources 440 may include a light emitting diode (LED). In exemplary embodiments of the present inventive concept, each of the light sources 440 may include an organic light emitting diode (OLED) or a laser diode (LD), for example.

In exemplary embodiments of the present inventive concept, the backlight assembly 400 may be a direct-type backlight assembly configured to directly provide light to a bottom surface of the display panel 500. However, the present inventive concept is not limited thereto. In exemplary embodiments of the present inventive concept, the backlight assembly 400 may be an edge-type backlight assembly. For example, the backlight assembly 400 may include a light guide plate (not shown) disposed between the reflective plate 410 and the first optical member 420. Light sources (not shown) may provide light to a sidewall of the light guide plate (not shown). Light provided to the sidewall of the light guide plate (not shown) may be guided to the display panel 500 by the light guide plate (not shown).

The light source printed circuit board 110 may be electrically connected to the driving printed circuit board 120. The light source printed circuit hoard 110 may be gripped by a socket 160 fixed to the driving printed circuit board 120. The socket 160 may include a first socket terminal 130 and a second socket terminal 140 spaced apart from the first socket terminal 130. The first and second socket terminals 130 and 140 may grip the light source printed circuit board 110.

The light source printed circuit board 110 may be fixed to the receiving member 620 by a combination member. The combination member may be a tape or a screw. In exemplary embodiments of the present inventive concept, the combination member may be a screw 411 and the light source printed circuit board 110 may have a screw-hole 412 combined with the screw 411. Thus, the light source printed circuit board 110 might not be dislodged by an external impact such that reliability of the display apparatus 700 may be increased.

The reflective plate 410 may include a material capable of reflecting light. For example, the reflective plate 410 may include polyethylene terephthalate (PET) or aluminum. The reflective plate 410 may be disposed on a bottom portion of the receiving member 620. The reflective plate 410 may reflect light generated from the light sources 440 to increase the amount of light used for displaying an image.

The first optical member 420 may be disposed between the display panel 500 and the light sources 440, so as to diffuse the light generated from the light sources 440. The second optical member 430 may be disposed between the display panel 500 and the first optical member 420. The second optical member 430 may include a plurality of optical films. For example, the second optical member 430 may include a prism film configured to condense light to increase front brightness, and a diffusion film configured to diffuse light outputted from the prism film.

In exemplary embodiments of the present inventive concept, the display panel 500 may be a liquid crystal display (LCD) panel. When the display panel 500 is an LCD panel, the display panel 500 may include a first substrate 520, a second substrate 510 facing the first substrate 520, and a liquid crystal layer (not shown) disposed between the first and second substrates 520 and 510. The first substrate 520 may include a plurality of pixels (not shown), and each of the pixels may include a thin film transistor and a pixel electrode (not shown) electrically connected to the thin film transistor.

The second substrate 510 may include color filters (not shown) disposed in one-to-one correspondence with the plurality of pixels. When the display panel 500 is the LCD panel, the second substrate 510 may include a common electrode (not shown). The common electrode and the pixel electrode may generate an electric field.

In exemplary embodiments of the present inventive concept, the color filters may be disposed on the first substrate 520, rather than the second substrate 510. The common electrode may be disposed on the first substrate 520, rather than the second substrate 510. When the common electrode is formed on the first substrate 520, the common electrode may be spaced apart from the pixel electrode and may generate a horizontal electric field along with the pixel electrode, and the liquid crystals of the liquid crystal layer may be directed by the horizontal electric field.

A source printed circuit board 530 may be electrically connected to the display panel 500 through a flexible circuit film 540. The source printed circuit board 530 may include a driving circuit (not shown) configured to drive the display panel 500. In exemplary embodiments of the present inventive concept, the source printed circuit board 530 may be separated from the driving printed circuit board 120 configured to drive the light source printed circuit board 110, as shown in FIG. 1. In exemplary embodiments of the present inventive concept, a driving circuit (no shown) configured to drive the light source printed circuit board 110 may be included in the source printed circuit board 530. The first socket terminal 130 and the second socket terminal 140 may be fixed to the source printed circuit board 530.

The receiving member 620 may include a bottom portion and sidewalls extending from the bottom portion. The receiving member 620 may provide a receiving space surrounded by the bottom portion and the sidewall. The reflective plate 410, the light source printed circuit board 110, the driving printed circuit board 120, the first socket terminal 130, the second socket terminal 140, the first optical member 420, and the second optical member 430 may be received in the receiving space. The display panel 500 may be disposed on the second optical member 430. The cover member 610 may cover an edge of the display panel 500 and may be combined with the receiving member 620.

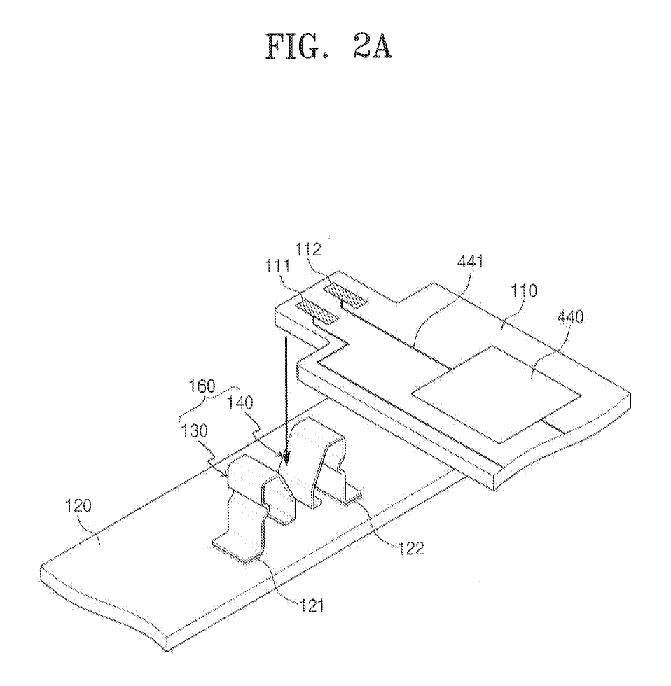

FIG. 2A is a separated perspective view showing a connection part of a light source printed circuit board and a driving printed circuit board in a display apparatus according to exemplary embodiments of the present inventive concept, and FIG. 2B is a combined perspective view showing a connecting part of a light source printed circuit board and a driving printed circuit board in a display apparatus according to exemplary embodiments of the present inventive concept.

Referring to FIGS. 2A and 2B, the first socket terminal 130 and the second socket terminal 140 may be fixed to the driving printed circuit board 120. The first socket terminal 130 and the second socket terminal 140 may be fixed to the driving printed circuit board 120 by a surface mounting technique (SMT). The first socket terminal 130 and the second socket terminal 140 may be spaced apart from each other and grip the light source printed circuit board 110 therebetween.

The light source printed circuit board 110 may include a first contact terminal 111 and a second contact terminal 112. Interconnections 441 and a plurality of light sources 440 may be disposed on the light source printed circuit board 110. The interconnections 441 may be electrically connected to the first and second contact terminals 111 and 112 in one-to-one correspondence. The light sources 440 may be electrically connected to the interconnections 441. Thus, the plurality of light sources 440 may generate light by power provided from a power source through the first and second contact terminals 111 and 112.

The driving printed circuit board 120 may include a first power source terminal 121 and a second power source terminal 122. The first contact terminal 111 may be electrically connected to the first power source terminal 121, and the second contact terminal 112 may be electrically connected to the second power source terminal 122. The power source may provide power to the first and second contact terminals 111 and 112 through the first and second power source terminals 121 and 122.

As illustrated in FIG. 2A, for example, the light source printed circuit board 110 may be inserted between the first socket terminal 130 and the second socket terminal 140 in a direction of an arrow illustrated in FIG. 2A. When each of the first and second socket terminals 130 and 140 has elasticity, the first and second socket terminals 130 and 140 may grip the light source printed circuit board 110 using the elasticity. In exemplary embodiments of the present inventive concept, the first and second socket terminals 130 and 140 may include a conductive material. For example, the first and second socket terminals 130 and 140 may include iron, aluminum, and/or copper.

The structure of the socket 160 may be applied to connections between various types of printed circuit boards. According to exemplary embodiments of the present inventive concept, the light source printed circuit board 110 may be gripped using the first and second socket terminals 130 and 140 fixed to the driving printed circuit board 120, so that the light source printed circuit board 110 is connected to the driving printed circuit board 120. Thus, an additional component (e.g., a connector) other than the first and second socket terminals 130 and 140 might not be used to connect the light source printed circuit board 110 to the driving printed circuit board 120. As a result, the number of components of the display apparatus 700 may be reduced and a manufacturing method of the display apparatus 700 may be simplified.

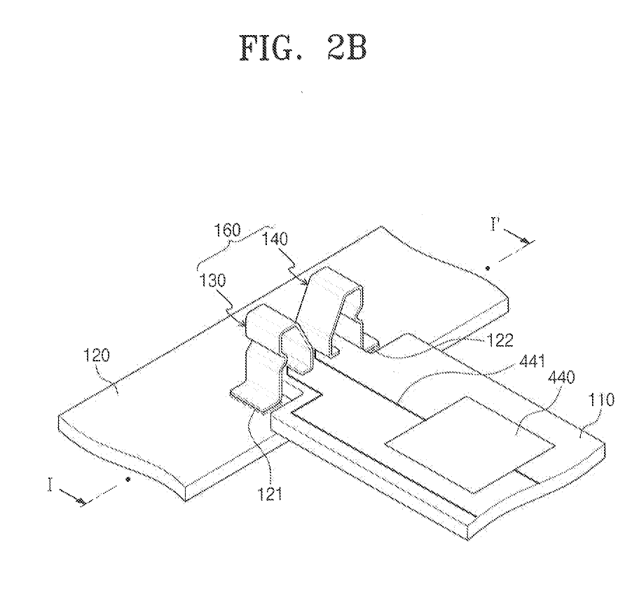

FIG. 3 is a cross-sectional view taken along a line I-I′ of FIG. 2B.

Referring to FIG. 3, the first socket terminal 130 may include a first combining portion 131, a first curved portion 132, and a first contact portion 133. The first combining portion 131 may be combined with the first power source terminal 121. The first contact portion 133 may be in contact with the first contact terminal 111. A contact area of the first contact portion 133 and the first contact terminal 111 may be equal to an area of the first contact terminal 111 in order to reduce a contact resistance between the first contact portion 133 and the first contact terminal 111. An area of a combined surface between the first combining portion 131 and the first power source terminal 121 may be equal to an area of the first power source terminal 121. The first curved portion 132 may extend from the first combining portion 131 and may be curved toward the first contact portion 133.

In exemplary embodiments of the present inventive concept, the first socket terminal 130 may include an assistant bent portion 150. The assistant bent portion 150 may be disposed between the first combining portion 131 and the first curved portion 132. The assistant bent portion 150 may increase the strength of the first socket terminal 130. Thus, the first socket terminal 130 may be prevented from being broken or transformed when the light source printed circuit board 110 is combined with the driving printed circuit board 120.

The first socket terminal 130 may receive an electrical current through the first curved portion 132. When the light source printed circuit board 110 is inserted between the first and second socket terminals 130 and 140, the first contact portion 133 may be moved toward the first combining portion 131 and may then return to its initial position by elasticity. The first contact portion 133 may grip the first contact portion 111, so as to be in contact with the first contact portion 111.

The second socket terminal 140 and the first socket terminal 130 may be symmetrical with respect to the light source printed circuit board 110. Thus, the second socket terminal 140 may have a similar structure to the first socket terminal 130. The structure of the second socket terminal 140 will be described in more detail below.

The second socket terminal 140 may include a second combining portion 141, a second curved portion 142, and a second contact portion 143. The second combining portion 141 may be combined with the second power source terminal 122. The second contact portion 143 may be in contact with the second contact terminal 112. The second curved portion 142 may extend from the second combining portion 141 and may be curved toward the second contact portion 143.

According to an exemplary embodiment of the present inventive concept, when the first socket terminal 130 includes a conductive material, the first power source terminal 121 may be electrically connected to the first contact terminal 111 through the first socket terminal 130. When the second socket terminal 140 includes the conductive material, the second power source terminal 122 may be electrically connected to the second contact terminal 112 through the second socket terminal 140.

According to exemplary embodiments of the present inventive concept, the first socket terminal 130 and the second socket terminal 140 may face each other with the light source printed circuit board 110 disposed therebetween. The first and second contact portions 133 and 143 may overlap with the light source printed circuit board 110, so as to grip the light source printed circuit board 110.

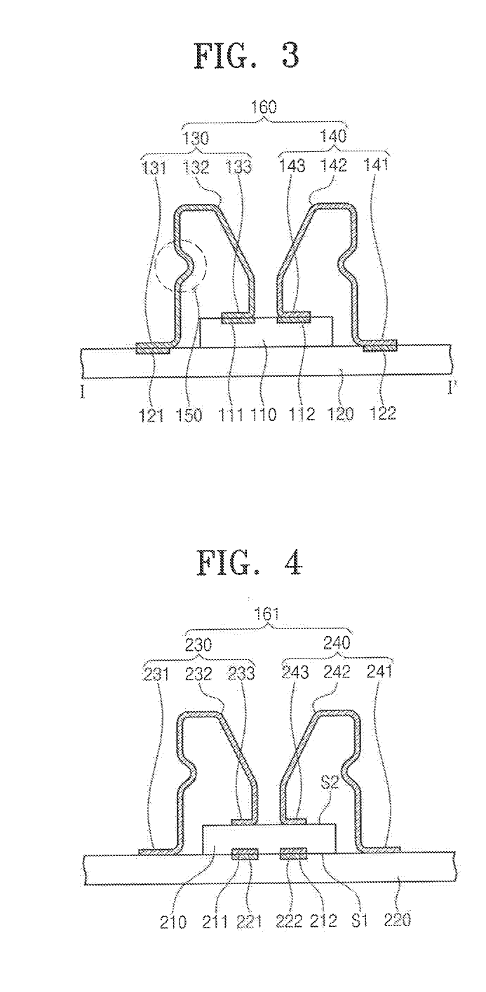

FIG. 4 is a cross-sectional view showing a connection part of a light source printed circuit board and a driving printed circuit board in a display apparatus according to an exemplary embodiment of the present inventive concept.

Referring to FIG. 4, a socket 161 may include a first socket terminal 230 and a second socket terminal 240. The first socket terminal 230 may include a first combining portion 231, a first curved portion 232, and a first contact portion 233. The second socket terminal 240 may include a second combining portion 241, a second curved portion 242, and a second contact portion 243. Each of the first and second socket terminals 230 and 240 may include a conductive material and/or a non-conductive material.

In an exemplary embodiment of the present inventive concept, a first power source terminal 221 and a second power source terminal 222 of a driving printed circuit board 220 may be disposed between the first combining portion 231 and the second combining portion 241. A light source printed circuit board 210 may have a first surface S1 and a second surface S2 opposite to each other. A first contact terminal 211 and a second contact terminal 212 may be disposed on the first surface S1 of the light source printed circuit hoard 210. The first contact portion 233 and the second contact portion 243 may be in contact with the second surface S2 of the light source printed circuit board 210, which is opposite to the first surface S1 on which the first and second contact terminals 211 and 212 are disposed. The first and second socket terminals 230 and 240 may grip the second surface S2 of the light source printed circuit board 210. The first power source terminal 221 and the second power source terminal 222 may be in contact with the first contact terminal 211 and the second contact terminal 212, respectively.

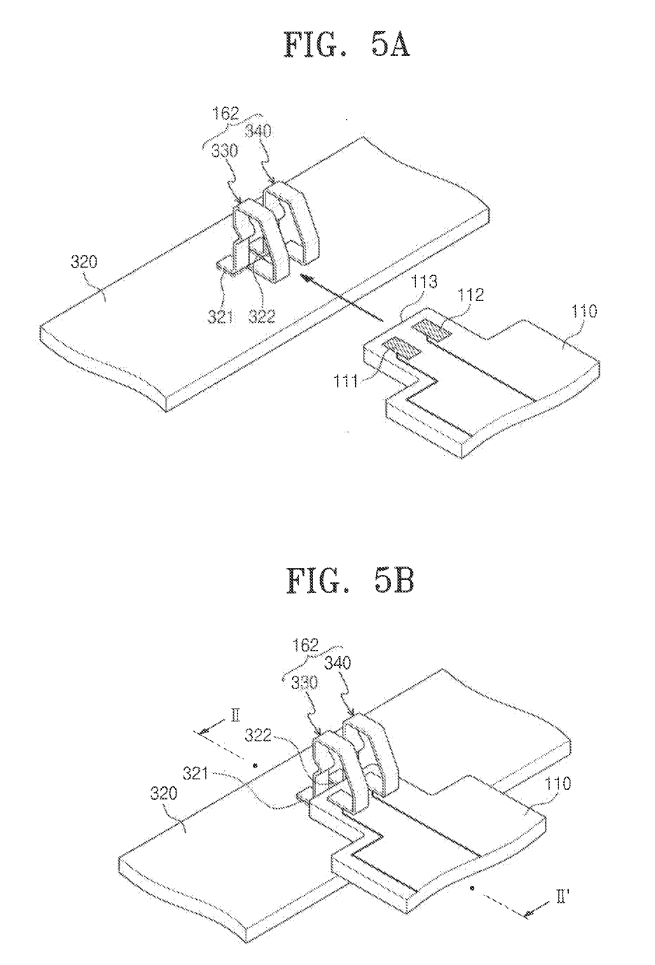

FIG. 5A is a separated perspective view showing a connection part of a light source printed circuit board and a driving printed circuit board in a display apparatus according to an exemplary embodiment of the present inventive concept, and FIG. 5B is a combined perspective view showing a connecting part of a light source printed circuit board and a driving printed circuit board in a display apparatus according to an exemplary embodiment of the present inventive concept.

In the exemplary embodiment discussed with reference to FIGS. 5A and 5B, the same elements as described above may be indicated by the same reference numerals and descriptions of the same elements may be omitted.

Referring to FIGS. 5A and 5B, a socket 162 may be fixed to a driving printed circuit board 320. The socket 162 may include a first socket terminal 330 and a second socket terminal 340. The first and second socket terminals 330 and 340 may face an edge portion 113 of the light source printed circuit board 110. The first socket terminal 330 and the second socket terminal 340 may be arranged along an edge portion 113 of a light source printed circuit board 110. The first and second socket terminals 330 and 340 may be arranged along a sidewall of the edge portion 113, which is perpendicular to an inserting direction of the light source printed circuit board 110.

According to the configuration shown in FIG. 5A, the light source printed circuit board 110 may be inserted into the first and second socket terminals 330 and 340 in a direction of an arrow illustrated in FIG. 5A. When each of the first and second socket terminals 330 and 340 has elasticity, the first and second socket terminals 330 and 340 may grip the light source printed circuit board 110 using the elasticity. In an exemplary embodiment of the present inventive concept, the light source printed circuit board 110 may be combined with the driving printed circuit board 320 by a sliding method.

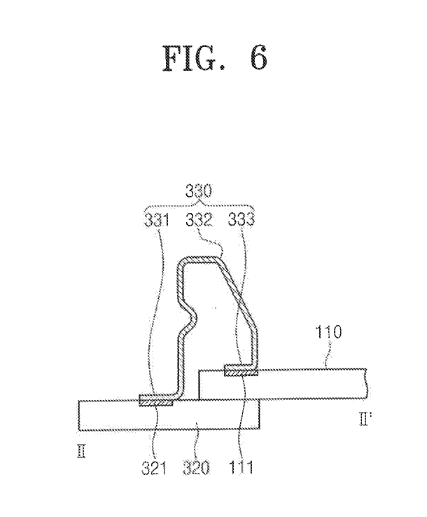

FIG. 6 is a cross-sectional view taken along a line II-II′ of FIG. 5B.

Referring to FIG. 6, a first socket terminal 330 may include a first combining portion 331, a first curved portion 332, and a first contact portion 333. The first combining portion 331 may be combined with a first power source terminal 321. The first contact portion 333 may be in contact with a first contact terminal 111. The first curved portion 332 may be curved from the first combining portion 331 toward the first contact portion 333. The second socket terminal 340 of FIGS. 5A and 5B may include a second combining portion, a second curved portion, and a second contact portion. The second combining portion may be combined with a second power source terminal 322 of FIGS. 5A and 5B, and the second contact portion may be in contact with the second contact terminal 112 of FIG. 5A. The second curved portion may be curved from the second combining portion toward the second contact portion.

In exemplary embodiments of the present inventive concept, the first socket terminal 330 may include a conductive material. The first power source terminal 321 may be electrically connected to the first contact terminal 111 through the first socket terminal 330.

In exemplary embodiments of the present inventive concept, a first power source terminal (not shown) may be disposed at a position corresponding to the first contact portion 333 on the driving printed circuit board 320, and a second power source terminal (not shown) may be disposed at a position corresponding to the second contact portion on the driving printed circuit board 320. The first contact portion 333 and the second contact portion may be in contact with an opposite surface to a surface of the light source printed circuit board 110 on which the first and second contact terminals 111 and 112 of FIG. 5A are disposed. Thus, the first contact portion 333 and the second contact portion may grip the light source printed circuit board 110. The first power source terminal may be in contact with the first contact terminal 111 of FIG. 5A, and the second power source terminal may be in contact with the second contact terminal 112 of FIG. 5A. The first and second socket terminals 330 and 340 may include a conductive material and/or a non-conductive material.

In the display apparatus according to exemplary embodiments of the present inventive concepts, the light source printed circuit board may be gripped by the first and second socket terminals fixed on the driving printed circuit board, so that the terminals of the light source printed circuit board are combined with the terminals of the driving printed circuit board. The display apparatus might not have an additional component (e.g., a connector) other than the first and second socket terminals. The number of components of the display apparatus may be reduced. The manufacturing method of the display apparatus may be simplified.

While the present inventive concept has been particularly shown and described with reference to exemplary embodiments thereof, it will be understood by those of ordinary skill in the art that various changes in form and detail may be made therein without departing from the spirit and scope of the present inventive concept.

What is claimed is:

1. A display apparatus, comprising:
a display panel configured to display an image; and
a backlight assembly configured to emit light onto the display panel,
wherein the backlight assembly comprises:
a light source printed circuit hoard including a first contact terminal and a second contact terminal;
a plurality of light sources disposed on the light source printed circuit board, wherein each of the plurality of light sources is configured to receive power through the first and second contact terminals to generate light;
a driving printed circuit board including a first power source terminal and a second power source terminal, wherein the driving printed circuit board is configured to provide power to the first and second contact terminals through the first and second power source terminals, respectively; and
a socket disposed on the driving printed circuit board, wherein the socket is configured to grip the light source printed circuit board, and wherein the socket is configured to electrically connect the light source printed circuit board to the driving printed circuit board.

2. The display apparatus of claim 1, wherein the socket comprises:
a first socket terminal disposed on the driving printed circuit board; and
a second socket terminal disposed on the driving printed circuit board and spaced apart from the first socket terminal, wherein the first socket terminal and the second socket terminal are configured to grip the light source printed circuit board.

3. The display apparatus of claim 2, wherein the first socket terminal comprises:
a first combining portion disposed on the driving printed circuit board;
a first contact portion disposed on the light source printed circuit board; and
a first curved portion, wherein the first curved portion is curved from the first combining portion toward the first contact portion, and wherein the first curved portion is configured to connect the first combining portion to the first contact portion, and
wherein the second socket terminal comprises:
a second combining portion disposed on the driving printed circuit board;
a second contact portion disposed on the light source printed circuit board; and
a second curved portion, wherein the second curved portion is curved from the second combining portion toward the second contact portion, and wherein the second curved portion is configured to connect the second combining portion to the second contact portion.

4. The display apparatus of claim 3, wherein the first and second socket terminals have elasticity by the first and second curved portions, respectively, and
wherein the light source printed circuit board is gripped by the first and second contact portions due to the elasticity of the first and second socket terminals.

5. The display apparatus of claim 3, wherein the first socket terminal and the second socket terminal face each other with the light source printed circuit board disposed therebetween, and
wherein the first contact portion and the second contact portion overlap with the light source printed circuit board, and wherein the first and second contact portions are configured to grip the light source printed circuit board.

6. The display apparatus of claim 3, wherein the first socket terminal and the second socket terminal face an edge portion of the light source printed circuit board and are disposed along the edge portion, and
wherein the first contact portion and the second contact portion overlap with the light source printed circuit board, and the first and second contact portions are configured to grip the light source printed circuit board.

7. The display apparatus of claim 3, further comprising:
a receiving member configured to receive the display panel and the backlight assembly; and
a combination member configured to fix the light source printed circuit board to the receiving member.

8. The display apparatus of claim 3, wherein each of the first and second socket terminals includes a conductive material,
wherein the first power source terminal is electrically connected to the first contact terminal through the first socket terminal, and
wherein the second power source terminal is electrically connected to the second contact terminal through the second socket terminal.

9. The display apparatus of claim 8, wherein the first combining portion is electrically connected to the first power source terminal,
wherein the second combining portion is electrically connected to the second power source terminal,
wherein the first contact portion is electrically connected to the first contact terminal, and
wherein the second contact portion is electrically connected to the second contact terminal.

10. The display apparatus of claim 3, wherein the light source printed circuit board comprises a first surface on which the first and second contact terminals are disposed; and a second surface opposite to the first surface,
wherein the first and second socket terminals are configured to grip the second surface of the light source printed circuit board,
wherein the first power source terminal is in contact with the first contact terminal, and
wherein the second power source terminal is in contact with the second contact terminal.

11. The display apparatus of claim 10, wherein the first power source terminal on the driving printed circuit hoard is disposed to correspond to a position of the first contact portion, and
wherein the second power source terminal on the driving printed circuit board is disposed to correspond to a position of the second contact portion.

12. The display apparatus of claim 10, wherein each of the first and second socket terminals includes a non-conductive material.

13. The display apparatus of claim 1, wherein each of the plurality of light sources is a light emitting diode (LED).

14. A backlight assembly, comprising:
a light source printed circuit board comprising a first contact terminal, a second contact terminal, and an edge portion;
a driving printed circuit board comprising a first power source terminal and a second power source terminal, wherein the first and second power source terminals are configured to provide power to the first and second contact terminals of the light source printed circuit hoard, respectively; and
a socket disposed on the driving printed circuit board, wherein the socket comprises a first socket terminal and a second socket terminal configured to grip the light source printed circuit board, wherein the first and second socket terminals face the edge portion of the light source printed circuit board, wherein the first socket terminal electrically connects the first power source terminal to the first contact terminal, and wherein the second socket terminal electrically connects the second power source terminal to the second contact terminal.

15. The backlight assembly of claim 14, further comprising a light source disposed on the light source printed circuit board, wherein the light source is configured to receive power provided through the first or second contact terminals.

16. The backlight assembly of claim 14, wherein each of the first and second sockets terminals include a conductive material.

17. The backlight assembly of claim 14, wherein each of the first and second socket terminals includes a non-conductive material.

18. The backlight assembly of claim 14, wherein each of the first and second socket terminals comprise a combining portion disposed on the driving printed circuit board, a contact portion disposed on the light source printed circuit board, and a curved portion connecting the combining portion and the contact portion.

19. The backlight assembly of claim 14, wherein each of the first and second socket terminals are flexible.

20. The backlight assembly of claim 14, wherein the backlight assembly further comprises a reflective plate.
